(19) United States
(12) Patent Application Publication
(10) Pub. No.: US 2025/0125638 A1
(43) Pub. Date: Apr. 17, 2025

(54) Power Management Circuit

(71) Applicant: Zgmicro Wuxi Corporation, Wuxi Jiangsu (CN)

(72) Inventors: Hang YIN, Wuxi (CN); Xiaodong Yang, Wuxi (CN)

(73) Assignee: Zgmicro Wuxi Corporation, Wuxi Jiangsu (CN)

(21) Appl. No.: 18/966,312

(22) Filed: Dec. 3, 2024

(30) Foreign Application Priority Data
Jun. 20, 2023 (CN) 2023107347835.5

(51) Int. Cl. H02J 7/00

(52) U.S. Cl. CPC H02J 7/00306; H02J 7/00032; H02J 7/0036; H02J 7/0048; H02J 7/0063; H02J 7/007182

(57) ABSTRACT

Power management circuit comprises: positive and negative terminals coupled to a charger or load; a battery having first and second battery terminals, the second battery terminal coupled to the negative terminal; a charger detector coupled between the positive terminal and the first battery terminal; a voltage conversion controller and a battery monitor coupled to the battery, the battery monitor monitoring the battery's voltage during discharging, and sending out an over-discharge signal to the charger detector and the voltage conversion controller; a conversion output circuit, coupled to the battery, having first and second switches, and an inductor, the first battery terminal supplying electric current to the inductor via the first switch, and the negative terminal supplying electric current to the inductor via the second switch. Thus, the risk caused by a parasitic body diode of the second switch can be prevented when multiple batteries are connected in series.

### CROSS-REFERENCE OF RELATED APPLICATIONS

This application claims priorities of Chinese Patent Application No. 202311673959.7 filed on Dec. 6, 2023, the entire content of which is incorporated herein by reference.

### BACKGROUND

### Field

The subject matter described herein relates to the field of battery management, and in particular to a power management circuit.

### Description of the Related Art

Dry batteries, which typically have an output voltage of 1.5V, are widely used in consumer electronics. With emergence of lithium batteries, sodium batteries and other energy storage cells, a solution has been developed to replace alkaline batteries. This solution uses a rechargeable battery along with a power management circuit to convert the cell's voltage to match the output voltage of an alkaline battery, enabling it to function as a dry battery replacement or an emulated dry battery. This approach offers advantages such as high power capacity and extended cycle life.

FIG. 1 is a schematic diagram showing a conventional power management circuit. As shown in FIG. 1, the power management circuit comprises a first voltage terminal P+, a second voltage terminal P−, a battery Bat, a voltage conversion controller 110, a charge controller 120, a discharge overvoltage detector (or battery monitor) 130, a charger detector 140, a conversion output circuit 150, and a charging switch MP2. The battery monitor 130 is configured to monitor the voltage of the battery Bat during the discharging process. The conversion output circuit 150 includes a first switch MP1, a second switch MN1, an inductor L, and a capacitor C. In one embodiment, the voltage conversion controller 110 can be a DC-DC buck convertor.

When the charger detector 140 detects the voltage at the first voltage terminal P+ is higher than the voltage at the first battery terminal VB of the battery Bat, it is determined that a charger is present or coupled between the first voltage terminal P+ and the second voltage terminal P−. The charger detector 140 activates the charge controller 120 via a charging-on signal CHRG_ON (i.e., a signal indicating charging of the battery is on) to supply a charging electric current through the charging switch MP2 to the battery. Simultaneously, operations of the voltage conversion controller 110 are shut down via the charging-on signal. At this point, the voltage conversion controller 110 sends out gate control signals P_DRV and N_DRV to turn off the first switch MP1 and the second switch MN1, respectively. The gate control signals P_DRV is at a high level, while the gate control signal N_DRV is at a low level.

When the battery monitor 130 determines that the voltage at the first battery terminal VB is too low (e.g., below a predefined threshold value), the battery monitor 130 shuts down the voltage conversion controller 110 via an over-discharge signal OD_STATE (i.e., a signal indicating the battery is over-discharged). Terms “high” and “low” used herein are relative to high-threshold and low-threshold values, respectively.

When the charger detector 140 detects the voltage at the first voltage terminal P+ is lower than the voltage at the first battery terminal VB of the battery Bat, it is determined that charger is absent or not coupled between the first voltage terminal P+ and the second voltage terminal P−. The charger detector 140 shuts down the charge controller 120 via a charging-on signal CHRG_ON (i.e., charging of the battery is off). Simultaneously, the charging switch MP2 is turn off via a gate control signal CHG_DRV (i.e., a signal indicating charging is off), which is at a high level. At this point, a valid charging-on signal is also sent to the voltage conversion controller 110 to allow normal operations.

When the battery monitor 130 determines the voltage at the first battery terminal VB is not excessively low, operations of the voltage conversion controller 110 are no longer prohibited via the over-discharge signal OD_STATE.

When the charger detector 140 detects the voltage at the first voltage terminal P+ is lower than the voltage at the first battery terminal VB, and the battery monitor 130 determines the voltage at the first battery terminal VB is not excessively low, then the voltage conversion controller 110 is allowed to operate normally, and the voltage conversion controller 110 sends control signals P_DRV and N_DRV to regulate P+/P− to supply an electric current with constant voltage.

When the voltage of the battery is too low, the voltage conversion controller 110 is shut down to ensure that the power of the battery does not decrease further. The first switch MP1 and the second switch MN1 are turn off in order to support charging from the P+/P−. However, turning off the second switch MN1 creates a safety risk, especially when multiple emulated dry batteries are connected in series.

FIG. 2 shows a schematic diagram showing a circuit structure of multiple conventional power management circuits (e.g., the power management circuit shown in FIG. 1) connected in series. When the power level of the battery Bat1 drops below a safe threshold, it triggers an over-discharge protection. The voltage conversion controller 110 of battery Bat1 turns off the second switch NM1 (disconnect). At this time, if the load LOAD connected to the series of batteries Bat1-Batn continues to draw load current I_LOAD from them, the load current will flow through the parasitic diode D1 of the second switch NM1 corresponding to battery Bat1. The load current in the parasitic diode D1 can lead to two risks: 1st risk: Due to the forward voltage of the parasitic diode D1, heat generation increases; 2nd risk: The forward conduction of the parasitic diode D1 may trigger conduction of the parasitic thyristor, increasing power consumption in the already low-power battery Bat1, potentially even triggering a latch-up effect.

Both of these risks could lead to damage to the device or chip. Therefore, it would be desirable to have a new improved technical solution to overcome the above problems.

### SUMMARY

One objective of the subject matter described herein is to provide a power management circuit that can prevent damage to the battery when it is used in series applications.

According to one aspect, a power management circuit disclosed herein includes: a positive terminal and a negative terminal coupled to a charger or an electric load, a battery having a first battery terminal and a second battery terminal, a conversion output circuit including a first switch, a second switch, an inductor, and a capacitor, wherein the capacitor is coupled between the positive and negative terminals, the first switch is coupled between the first battery terminal and an intermediate node A, the inductor is coupled between the intermediate node A and the positive terminal, the second battery terminal is coupled to the negative terminal, and the second switch is coupled between the intermediate node A and the negative terminal. The power management circuit further includes a voltage conversion controller, coupled between the first and second battery terminal, having a first control output terminal coupled to the control terminal of the first switch, and a second control output terminal coupled to the control terminal of the second switch; charging switch coupled between the intermediate node A and the first battery terminal; a charge controller having a charging control output terminal coupled to the control terminal of the charging switch; a battery monitor, coupled between the first and second battery terminals, for detecting whether the battery is over-discharged. When the battery is over-discharged, the battery monitor outputs a valid over-discharge signal to the voltage conversion controller. When the battery is over-discharged and charger is absent, the voltage conversion controller is shut down, the first switch is turned off, and the second switch is turned on. When the battery is over-discharged and a charger is present, the voltage conversion controller is shut down, and both the first and second switches are turned off. When the battery is not over-discharged beyond a predefined safe threshold, the battery monitor outputs an invalid over-discharge signal to the voltage conversion controller. When the battery is not over-discharged and charger is absent, the voltage conversion controller maintains normal operations, both the first and second switches are turned on. Electric current with a predefined output voltage flows from the positive terminal to the negative terminal. When the battery is not over-discharged and a charger is present, the voltage conversion controller is shut down, and both the first and second switches are turned off.

According to another aspect, when the over-discharge signal is valid (indicating excessively low voltage in the battery) and charger is absent, the voltage conversion controller stops operating and the first switch is switched off while the second switch is switched on. When the over-discharge signal is valid and a charger is present, the voltage conversion controller is shut down, and both the first and second switches are turned off. When the over-discharge signal is invalid (indicating the battery's voltage is not too low) and charger is absent, the voltage conversion controller maintains normal operations, and both the first switch and the second switch are turned on. When the over-discharge signal is invalid and a charger is present, the voltage conversion controller is shut down, and both the first switch and the second switch are turned off. This design helps prevent damage to the battery when multiple batteries are connected in series.

### BRIEF DESCRIPTION OF THE DRAWINGS

These and other features, aspects, and advantages of the subject matter will be better understood with regards to the following description, appended claims, and accompanying drawings as follows:

FIG. 1 shows a schematic diagram of a conventional power management circuit;

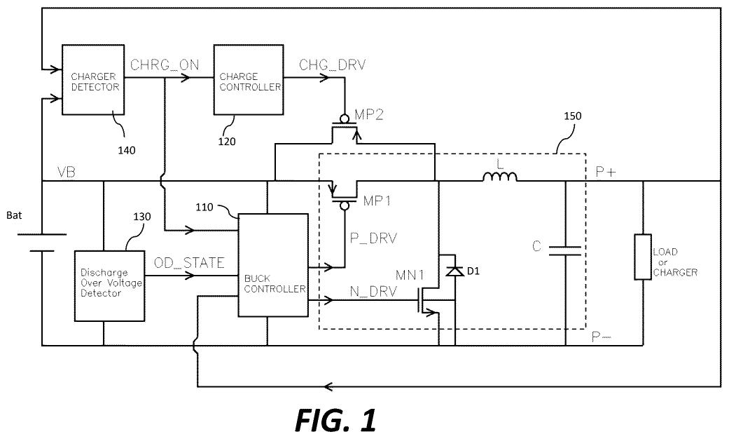

FIG. 2 shows a schematic diagram of a power management circuit with multiple conventional power management circuits shown in FIG. 1 connected in series; and

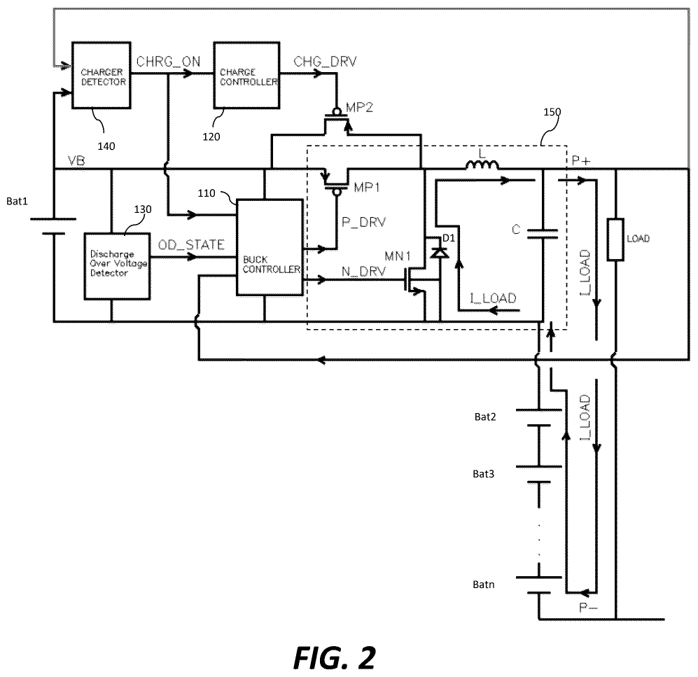

FIG. 3 shows a schematic diagram of an improved power management circuit according to one embodiment.

### DETAILED DESCRIPTION OF THE PREFERRED EMBODIMENTS

The detailed description is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the subject matter. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments does not inherently indicate any particular order nor imply any limitations in the subject matter.

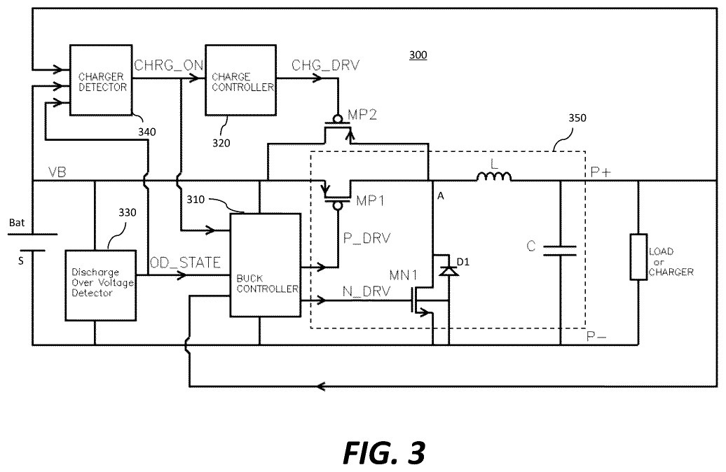

FIG. 3 is a schematic diagram showing a power management circuit 300 according to one embodiment. The power management circuit 300 includes a first voltage or positive terminal P+, a second voltage or negative terminal P−, a battery Bat, a voltage conversion controller 310, a charge controller 320, a battery monitor 330, a charger detector 340, and a conversion output circuit 350.

The battery Bat includes a first battery terminal VB and a second battery terminal S. The conversion output circuit 350 includes a first switch MP1, a second switch MN1, an inductor L, and a capacitor C. The capacitor C is coupled between the first voltage terminal P+ and the second voltage terminal P−, and the first switch MP1 is coupled between the first battery terminal VB and an intermediate node A. The inductor L is coupled between the intermediate node A and the first voltage terminal P+. The second battery terminal S is coupled to the second voltage terminal P−. The second switch MN1 is coupled between the intermediate node A and the second voltage terminal P−. The voltage conversion controller 310 is coupled between the first battery terminal VB and the second battery terminal S, and includes a first control output terminal, a second control output terminal, and a feedback input terminal. The first control output terminal is coupled to a control terminal of the first switch MP1, and the second control output terminal is coupled to a control terminal of the second switch MN1. As shown in FIG. 3, a charging switch MP2 is coupled between the intermediate node A and the first battery terminal VB. A charging control output terminal of the charge controller 320 is coupled to a control terminal of the charging switch MP2. In another embodiment, the charging switch MP2 can also be coupled between the first voltage terminal P+ and the first battery terminal VB. Regardless where the charging switch MP2 is located, the battery needs to be charged through the first voltage terminal P+ and the charging switch MP2.

The battery monitor 330 is coupled between the first battery terminal VB and the second battery terminal S, and is configured to detect whether the battery Bat is over-discharged. Specifically, the battery monitor 330 determines whether the voltage or power of the battery Bat is too low (e.g., comparing the voltage of the first battery terminal VB with a predefined voltage threshold value).

When the battery Bat is over-discharged, the over-discharge signal OD_STATE is set to valid or true in the battery monitor 330. The signal OD_STATE is then sent to both the voltage conversion controller 310 and the charger detector 340. When the over-discharge signal is valid and charger is absent, the voltage conversion controller 310 shuts down and sends out output control signals P_DRV and N_DRV to turn off the first switch MP1 and to turn on the second switch MN1, respectively. When the over-discharge signal is valid and the charger is present, the voltage conversion controller 310 shuts down and sends out the control signals P_DRV and N_DRV to turn off both the first switch MP1 and the second switch MN1.

When the battery Bat is not over-discharged, the over-discharge signal OD_STATE is set to invalid or false in the battery monitor 330. The signal OD_STATE is then sent to both the voltage conversion controller 310 and the charger detector 340. When the over-discharge signal OD_STATE is invalid and charger is absent, the voltage conversion controller 310 maintains normal operations, and sends out control signals P_DRV and N_DRV to alternately turn on the first switch MP1 and the second switch MN1 for an electric current driven by a predefined output voltage through the first voltage terminal P+ and the second voltage terminal P−. When the over-discharge signal OD_STATE is invalid and a charger is present, the voltage conversion controller 310 shuts down, and sends out control signals P_DRV and N_DRV to turn off both the first switch MP1 and the second switch MN1. Therefore, when the charger is present, the voltage conversion controller 310 turns off or switches off both the first switch and the second switch regardless whether the battery is over-discharged or not.

The first voltage terminal P+ is coupled to the feedback input of the voltage conversion controller 310. During normal operations, the voltage conversion controller 310 sends out the control signals P_DRV and N_DRV according to the voltage at the first voltage terminal P+ to alternately turn on the first switch MP1 and the second switch MN1. As a result, electric current with the predefined voltage flows from the first voltage terminal P+ and the second voltage terminal P+.

In another embodiment, the second switch MN1 includes a plurality of switching units coupled in parallel. When the over-discharge signal OD_STATE is valid and charger is absent, the voltage conversion controller 310 turns off the first switch MP1, and turns on all or part of the switching units in the second switch MN1.

The charger detector 340 is electrically coupled between the first voltage terminal P+ and the first battery terminal VB for determining whether a charger is present between the first voltage terminal P+ and the second voltage terminal P−. The charger detector 340 has a control input terminal for receiving the over-discharge signal OD_STATE from the battery monitor 330, and an output terminal for sending out charging-on signal CHRG_ON to the voltage converter controller 310. The charging-on signal CHRG_ON represents whether or not a charger is present between the first voltage terminal P+ and the second voltage terminal P−.

Based on different states of the over-discharge signal OD_STATE, the charge detector 340 can properly determine whether to engage the charger. When the over-discharge signal OD_STATE is invalid or false, the charger detector 340 determines whether or not a charger is present between the first voltage terminal P+ and the second voltage terminal P−. When the voltage at the first voltage terminal P+ is higher than the voltage at the first battery terminal VB, it is determined that a charger is present. When the voltage of the first voltage terminal P+ is lower than the voltage at the first battery terminal VB, it is determined that charger is absent. If a charger is present, the charging-on signal CHRG_ON is set to valid and then sent to the charge controller 320 and the voltage conversion controller 310, which starts operations of the charge controller 320. At this point, the charge controller 320 turns on the charging switch MP2 to supply a charging current to the battery Bat, shuts down the voltage conversion controller 310, and turns off both the first switch MP1 and the second switch MN1. If charger is absent, the charging-on signal CHRG_ON is set to invalid and then sent to the charge controller 320 and the voltage conversion controller 310, which shuts down the charge controller 320. At this point, the charge controller 320 turns off the charging switch MP2. The voltage conversion controller 310 maintains normal operations.

When the over-discharge signal OD_STATE is valid, the charger detector 340 determines whether a charger is present by comparing the voltage at the first voltage terminal P+ and a predetermined reference voltage Vref_chg_od. If the voltage at the first voltage terminal P+ is higher than the predetermined reference voltage Vref_chg_od, a valid charging-on signal CHRG_ON is sent to the charge controller 320 and the voltage conversion controller 310 to start operations of the charge controller 320. When the battery is over-discharged and a charger is present, the charge controller 320 controls a charging current to the battery Bat via the charging switch MP2. Simultaneously, the voltage conversion controller 310 switches off both the first switch MP1 and the second switch MN1.

If the voltage at the first voltage terminal P+ is lower than the predetermined reference voltage Vref_chg_od, it is determined that charger is absent, the charging-on signal CHRG_ON is set to invalid and then sent to the charge controller 320 and the voltage conversion controller 310, which shuts down the charge controller 310. When the over-discharge signal OD_STATE is valid and charger is absent, and the charge controller 310 turns off the charging switch MP2, turns off the first switch MP1, and turns on the second switch MN1.

In one embodiment, in a selectable interval between OV and a voltage pulse amplitude value generated by a current pulse, flowing through the conductive second switch MN1, outputted by the charger during a short-circuit, an appropriate voltage is selected as the predetermined reference voltage Vref_chg_od in a battery over-discharge protection state (i.e., the over-discharge signal OD_STATE is valid).

In another embodiment, the first switch is a PMOS (P-channel Metal Oxide Semiconductor) transistor, the charging switch can be a PMOS transistor, and the second switch can be an NMOS (N-channel Metal Oxide Semiconductor) transistor.

The first switch MP1 can be a transistor having a drain, a source, and a gate. The drain and the source are configured as a first connecting terminal and a second connecting terminal, respectively, while the gate is configured as a control terminal. The first switch MP1 is turned off when its control terminal is at a high level, and turned on when its control terminal is at a low level. The source of the first switch MP1 is coupled to the first battery terminal, while the drain of the first switch MP1 is coupled to the intermediate node A. Similarly, the second switch MN1 can be a transistor having a drain and a source respectively configured as a first connecting terminal and a second connecting terminal, and a gate configured as a control terminal thereof. The second switch MN1 is turned on when its control terminal is at the high level, and turned off when its control terminal is at the low level. The source of the second switch MN1 is coupled to the second voltage terminal P−, while the drain of the second switch MN1 is coupled to the intermediate node A. Further, the charging switch MP2 can also be a transistor having a drain and a source respectively configured as a first connecting terminal and a second connecting terminal, and a gate configured as a control terminal thereof. The charging switch MP2 is turned off when its control terminal is at the high level, and turned on when its control terminal is at the low level. The source of the charging switch MP2 is coupled to the intermediate node A, while the drain of the charging switch MP2 is coupled to the first battery terminal VB.

In another embodiment, the source of the charging switch MP2 is coupled to the first voltage terminal P+, and the drain of the charging switch MP2 is coupled to the first battery terminal VB. Regardless where the source is coupled to, the charging switch MP2 must ensure that the battery can be charged through the first voltage terminal P+ and the charging switch MP2.

FIG. 3 shows that a load LOAD or charger is present between the first voltage terminal P+, and the second voltage terminal P−.

In one embodiment, when the over-discharge signal is valid (that is, in a battery over-discharge protection state) and charger is absent, the voltage conversion controller is shut down, and the first switch MP1 is turned off and the second switch MN1 is turned on, instead of directly turning off the second switch MN1 as in the prior art, so that when the batteries are connected in series, the risk caused by a parasitic body diode D1 of the second switch MN1 described in the prior art is eliminated, and the damage of the device or the chip is avoided. In other words, the battery Bat in the power management circuit 300 can be used together with other batteries in series without the risk in the prior art. Furthermore, when the battery is over-discharged and a charger is present, the voltage conversion controller is shut down, and the first switch and the second switch are turned off, so that charging current can be supplied from the first voltage terminal P+ to the second voltage terminal P−. Moreover, when the battery is over-discharged, the condition for the charger detector to determine whether the charger is coupled becomes whether the voltage of the first voltage terminal is higher than a predetermined reference voltage, so that the hidden danger of batteries connected in series is eliminated and sharing of load and charger ports in the battery management circuit is realized.

Terms “connecting”, “connected”, “connected”, “coupled” “couple” and other words denoting an electrical connection, if not otherwise specified, denote a direct or indirect electrical connection.

Although preferred embodiments have been described, additional changes and modifications to these embodiments may be made once the basic creative concepts are known to those skilled in the art. The appended claims are therefore intended to be interpreted to comprise preferred embodiments and all changes and modifications falling within the scope of this application. A person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A circuit for managing power comprising:
a positive terminal and a negative terminal coupled to a charger or an electric load;
a battery having a first battery terminal and a second battery terminal, the second battery terminal coupled to the negative terminal;
a charger detector coupled between the positive terminal and the first battery terminal;
a voltage conversion controller coupled to the battery; and
a battery monitor coupled to the battery, the battery monitor monitoring the battery's voltage during discharging, and sending out an over-discharge signal to both the charger detector and the voltage conversion controller.

2. The circuit according to claim 1, further comprises a conversion output circuit coupled to the battery, the conversion output circuit having a first switch, a second switch, and an inductor, the first battery terminal supplying electric current to the inductor via the first switch, and the negative terminal supplying electric current to the inductor via the second switch.

3. The circuit according to claim 2, wherein the voltage conversion controller comprises a first control output terminal coupled to a control terminal of the first switch, and a second control output terminal coupled to a control terminal of the second switch.

4. The circuit according to claim 2, wherein, when the battery is over-discharged and the charger is absent, the voltage conversion controller alternately turns on the first switch and the second switch such that an electric current with a predefined output voltage flows between the positive terminal and the negative terminal.

5. The circuit according to claim 2, wherein the voltage conversion controller turns off both the first switch and the second switch when the charger is detected by the charger detector.

6. The circuit according to claim 2, wherein the second switch comprises a plurality of switching units, wherein the voltage conversion controller shuts down operations and turns off the first switch and turns on at least part of the switching units when the battery is over-discharged and the charger is absent.

7. The circuit according to claim 2, wherein the first switch is coupled between the first battery terminal and an intermediate node, the inductor is coupled between the intermediate node and the positive terminal, and the second switch is coupled between the intermediate node and the negative terminal.

8. The circuit according to claim 1, wherein the over-discharge signal is set to be valid when the battery is over-discharged, and wherein the over-discharge signal is set to be invalid when the battery is not over-discharged.

9. The circuit according to claim 1, wherein the positive terminal is coupled to a feedback input of the voltage conversion controller.

10. The circuit according to claim 1, wherein the battery monitor detects whether the battery is over-discharged by comparing the first battery terminal's voltage with a predefined voltage threshold value.

11. The circuit according to claim 10, wherein the charger detector comprises an input terminal for receiving the over-discharge signal, and an output terminal for sending out a charging-on signal indicating whether electric charging current is on.

12. The circuit according to claim 11, wherein, when the battery is over-discharged, the charging-on signal is set to valid if the positive terminal's voltage is higher than a predetermined reference voltage; wherein the charging-on signal is set to invalid, if the positive terminal's voltage is lower than the predetermined reference voltage.

13. The circuit according to claim 11, wherein the predetermined reference voltage is a voltage between OV and a voltage pulse amplitude value generated by a current pulse, flowing through the second switch, outputting by the charger during a short-circuit.

14. The circuit according to claim 1, wherein the charger detector compares the positive terminal's voltage with the first battery terminal's voltage to determine whether the charger is present.

15. The circuit according to claim 14, the charger detector determines the charger is present if the positive terminal's voltage is higher than the voltage of the first battery terminal's voltage.

16. The circuit according to claim 14, the charger detector determines the charger is absent if the positive terminal's voltage is lower than the voltage of the first battery terminal's voltage.

17. The circuit according to claim 1, further comprising:
a charging switch;
a charge controller having a charge control output terminal coupled to the charge switch, the charge control output terminal sending out a signal indicating whether charging the battery is valid or not;
when the signal is valid, the charge controller turns on the charging switch to let a charging current flow through,
when the signal is invalid, the charge controller turns off the charging switch.

18. The circuit according to claim 17, wherein the charging switch comprises a P-channel Metal Oxide Semiconductor transistor having a drain and a source respectively configured as a first connecting terminal and a second connecting terminal, and a gate configured as a control terminal, the charging switch is turned off when the control terminal is at a high level, and the charging switch is turned on when the control terminal is at a low level.

19. The circuit according to claim 7, wherein the first switch comprises a P-channel Metal Oxide Semiconductor transistor having a drain, a source, and a gate, the drain and the source respectively configured as a first connecting terminal and a second connecting terminal, the gate configured as a control terminal, the first switch is turned off when the control terminal is at a high level, and the first switch is turned on when the control terminal is at a low level, and the source of the first switch is coupled to the first battery terminal, and the drain of the first switch is coupled to the intermediate node.

20. The circuit according to claim 19, wherein the second switch is an N-channel Metal Oxide Semiconductor transistor having a drain, a source, and a gate, the drain and the source respectively configured as a first connecting terminal and a second connecting terminal, the gate configured as a control terminal, and the second switch is turned on when the control terminal is at the high level, and the second switch is turned off when the control terminal is at the low level, and the source of the second switch is coupled to the second voltage terminal, and the drain of the second switch is coupled to the intermediate node.
